(19) United States
(12) Patent Application Publication
(10) Pub. No.: US 2025/0328731 A1
(43) Pub. Date: Oct. 23, 2025

(54) TYPEAHEAD IMAGE GENERATION

(71) Applicant: META PLATFORMS, INC., Menlo Park, CA (US)

(72) Inventors: Asaf Gelber, New York, NY (US); John Hanlon, Brooklyn, NY (US); Ankit Jain, Fremont, CA (US); Hyunbin Park, Redwood City, CA (US); Tarek Hefny, Redmond, WA (US); Catherine Suzanne Trono, San Francisco, CA (US); Mayank Sanganeria, Berkeley, CA (US); Yongkai Wang, Jersey City, NJ (US)

(21) Appl. No.: 19/094,499

(22) Filed: Mar. 28, 2025

Related U.S. Application Data
(60) Provisional application No. 63/635,550, filed on Apr. 17, 2024.

(51) Int. Cl. G06F 40/274; G06F 40/289; G06T 11/00

(52) U.S. Cl. CPC G06F 40/274; G06F 40/289; G06T 11/00; G06T 2200/24

(57) ABSTRACT

A system and method for typeahead image generation are provided. The method may include receiving, via a user interface during a prompting session, a text prompt describing an image. The method also may include generating, via a trained diffusion model, the image representative of the text prompt. The method further may include determining, via the trained diffusion model, a reconciled risk score based on a determined risk score of the text prompt and a determined risk score of the generated image. The method even further may include causing, via the trained diffusion model in response to the determined reconciled risk score, to (i) approve the generated image in an instance in which the determined reconciled risk score meets or exceeds a predetermined threshold, or (ii) deny the generated image in an instance in which the determined reconciled risk score fails to meet the predetermined threshold.

### CROSS-REFERENCE TO RELATED APPLICATIONS

The instant application claims the benefit of priority to U.S. Provisional application No. 63/635,550 filed Apr. 17, 2024 entitled, “Typehead Image Generation” the contents of which is incorporated by reference in its entirety herein.

### TECHNOLOGICAL FIELD

Examples of the present disclosure relate generally to methods, devices, and computer program products for typeahead and near real-time image generation.

### BACKGROUND

Text-to-image models include advanced artificial intelligence (AI) systems designed to generate visual content from textual descriptions. These models leverage deep learning techniques, such as generative adversarial networks (GANs), diffusion models, or other variations of transformer architectures, which have been adapted for visual tasks.

The process of image generation may involve encoding text inputs (prompts) using a transformer-based text encoder, which captures the semantic nuances of a prompt. The encoded text may then be fed into an image-generating model that synthesizes the image by mapping the encoded text to visual elements. Text-to-image generation may require substantial computational resources due to the complexity of the models and the high dimensionality of the output space (images).

A challenge with text-to-image models includes the interaction workflow, which may be time-consuming and inefficient for a user's iterative creative processes. For example, when a user inputs a textual prompt, the model may process the prompt to produce an image, which may take a considerable amount of time depending on the model's complexity and the computational resources involved. If the generated image does not meet the user's expectations or if they wish to modify the prompt to refine the output, the user must revise the prompt and resubmit it for processing, starting the wait cycle anew. This iterative process of tweaking and waiting for the output is not only time-consuming but also breaks the creative flow, making it less practical for applications where rapid prototyping or iterative design adjustments are required.

### BRIEF SUMMARY

The subject technology is directed to diffusion model distillation frameworks tailored to enable high-fidelity, diverse sample generation in a few steps (e.g., as few as one to three steps). The subject technology is also directed to typeahead image generation that enables users to quickly make prompt modifications and image generations.

One aspect of the exemplary aspects is directed to a method. The method may include receiving, via a user interface during a prompting session, a text prompt describing an image. The method may also include generating, via a trained diffusion model, the image representative of the text prompt. The method further may include determining, via the trained diffusion model, a reconciled risk score based on a determined risk score of the text prompt and a determined risk score of the generated image. The method even further may include causing, via the trained diffusion model in response to the determined reconciled risk score, to (i) approve the generated image in an instance in which the determined reconciled risk score meets or exceeds a predetermined threshold, or (ii) deny the generated image in an instance in which the determined reconciled risk score fails to meet the predetermined threshold.

Another aspect of the exemplary aspects is directed to a system. The system includes a non-transitory memory including instructions stored thereon. The system may include a processor, operably coupled to the non-transitory memory, configured to execute stored instructions of receiving, via a user interface during a prompting session, a text prompt describing an image. The stored instructions also may include generating, via a trained diffusion model, the image representative of the text prompt. The stored instruction further may include determining, via the trained diffusion model, a reconciled risk score based on a determined risk score of the text prompt and a determined risk score of the generated image. The stored instruction even further may include causing, via the trained diffusion model in response to the determined reconciled risk score, to (i) approve the generated image in an instance in which the determined reconciled risk score meets or exceeds a predetermined threshold, or (ii) deny the generated image in an instance in which the determined reconciled risk score fails to meet the predetermined threshold.

Another aspect of the exemplary aspects is directed to a non-transitory computer readable medium including stored instructions that when executed by a processor effectuate receiving, via a user interface during a prompting session, a text prompt describing an image. The medium also includes stored instructions to generate, via a trained diffusion model, the image representative of the text prompt. The medium further includes stored instructions to determine, via the trained diffusion model, a reconciled risk score based on a determined risk score of the text prompt and a determined risk score of the generated image. The medium even further includes stored instructions to cause, via the trained diffusion model in response to the determined reconciled risk score, to (i) approve the generated image in an instance in which the determined reconciled risk score meets or exceeds a predetermined threshold, or (ii) deny the generated image in an instance in which the determined reconciled risk score fails to meet the predetermined threshold.

Additional advantages will be set forth in part in the description that follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, examples of the disclosed subject matter are shown in the drawings; however, the disclosed subject matter is not limited to the specific methods, compositions, and devices disclosed. In addition, the drawings are not necessarily drawn to scale. In the drawings:

FIG. 1 illustrates a diagram of an exemplary network environment, in accordance with one or more example aspects of the subject technology.

FIG. 2 illustrates a diagram of an exemplary communication device, in accordance with one or more example aspects of the subject technology.

FIG. 3 illustrates an exemplary computing system, in accordance with one or more example aspects of the subject technology.

FIG. 4 illustrates a machine learning and training model framework, in accordance with example aspects of the present disclosure.

FIG. 5 illustrates a box diagram of an example process for training and distilling a diffusion model, in accordance with one or more example aspects of the subject technology.

FIG. 6 depicts a component of a distillation framework for distilling a diffusion model, in accordance with one or more example aspects of the subject technology.

FIG. 7 depicts another component of a distillation framework for distilling a diffusion model, in accordance with one or more example aspects of the subject technology.

FIGS. 8A, 8B, 8C, 8D and 8E depict a typeahead user interface 800 for utilizing a trained diffusion model, in accordance with one or more example aspects of the subject technology.

FIG. 9 depicts a block diagram of an example prompt processing pipeline, in accordance with one or more example aspects of the subject technology.

FIG. 10 depicts an example flowchart in accordance with one or more example aspects of the subject technology.

The figures depict various examples for purposes of illustration only. One skilled in the art will readily recognize from the following discussion that alternative examples of the structures and methods illustrated herein may be employed without departing from the principles described herein.

### DETAILED DESCRIPTION

Some examples of the subject technology will now be described more fully hereinafter with reference to the accompanying drawings, in which some, but not all examples of the subject technology are shown. Indeed, various examples of the subject technology may be embodied in many different forms and should not be construed as limited to the examples set forth herein. Like reference numerals refer to like elements throughout.

As used herein, the terms “data,” “content,” “information,” and similar terms may be used interchangeably to refer to data capable of being transmitted, received and/or stored in accordance with examples of the disclosure. Moreover, the term “exemplary,” as used herein, is not provided to convey any qualitative assessment, but instead merely to convey an illustration of an example. Thus, use of any such terms should not be taken to limit the spirit and scope of examples of the disclosure.

As defined herein, a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, an “application” may refer to a computer software package that may perform specific functions for users and/or, in some cases, for another application(s). An application(s) may utilize an operating system (OS) and other supporting programs to function. In some examples, an application(s) may request one or more services from, and communicate with, other entities via an application programming interface (API).

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of augmented/virtual/mixed reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

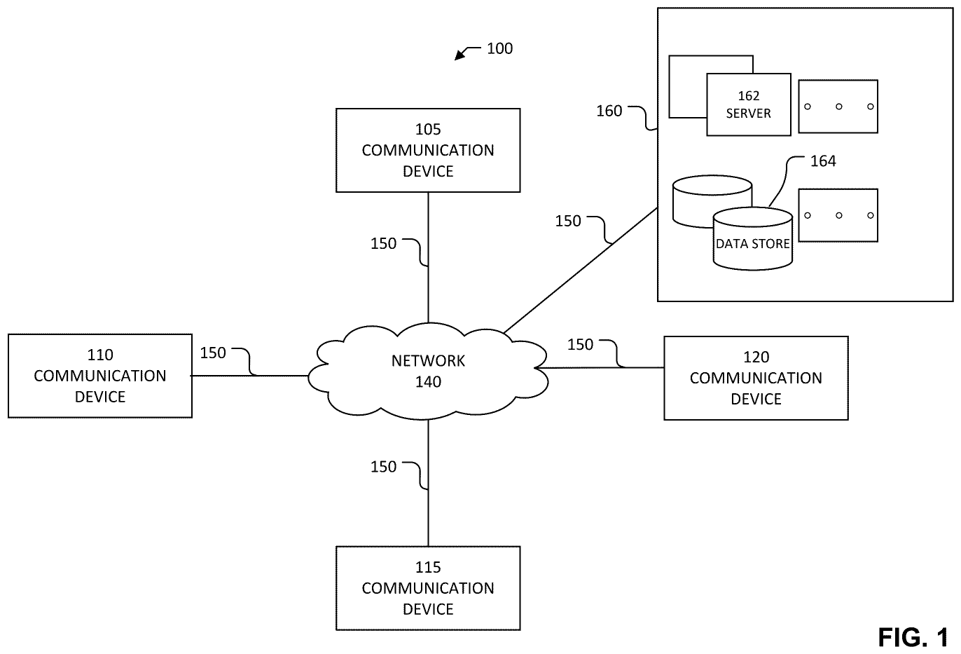

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140. In other examples, the network 140 may be any suitable network capable of provisioning content and/or facilitating communications among entities within, or associated with the network 140. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wired and/or wireless links, such as, for example, Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH). In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as, for example, a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

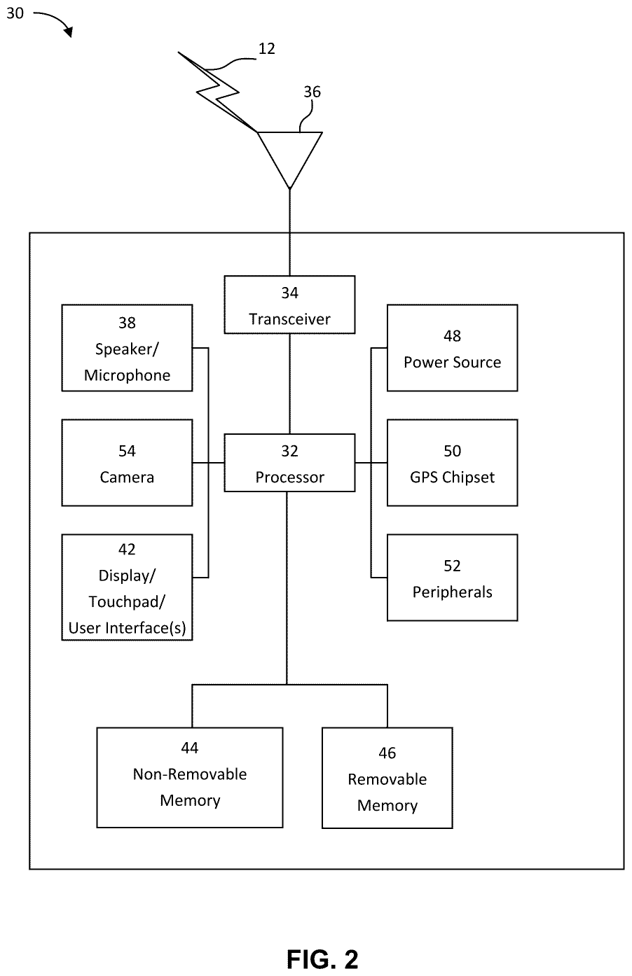

FIG. 2 illustrates a block diagram of an exemplary hardware/software architecture of a communication device such as, for example, user equipment (UE) 30. In some exemplary respects, the UE 30 may be any of communication devices 105, 110, 115, 120. In some exemplary aspects, the UE 30 may be a computer system such as, for example, a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a display, touchpad, and/or user interface(s) 42, a power source 48, a GPS chipset 50, and other peripherals 52. In some exemplary aspects, the display, touchpad, and/or user interface(s) 42 may be referred to herein as display/touchpad/user interface(s) 42.

The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptacle and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example. The non-removable memory 44 and/or the removable memory 46 may be computer-readable storage mediums. For example, the non-removable memory 44 may include a non-transitory computer-readable storage medium and a transitory computer-readable storage medium.

The processor 32 is coupled to its communication circuitry (e.g., transceiver 34 and transmit/receive element 36). The processor 32, through the execution of computer-executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

### Exemplary Computing System

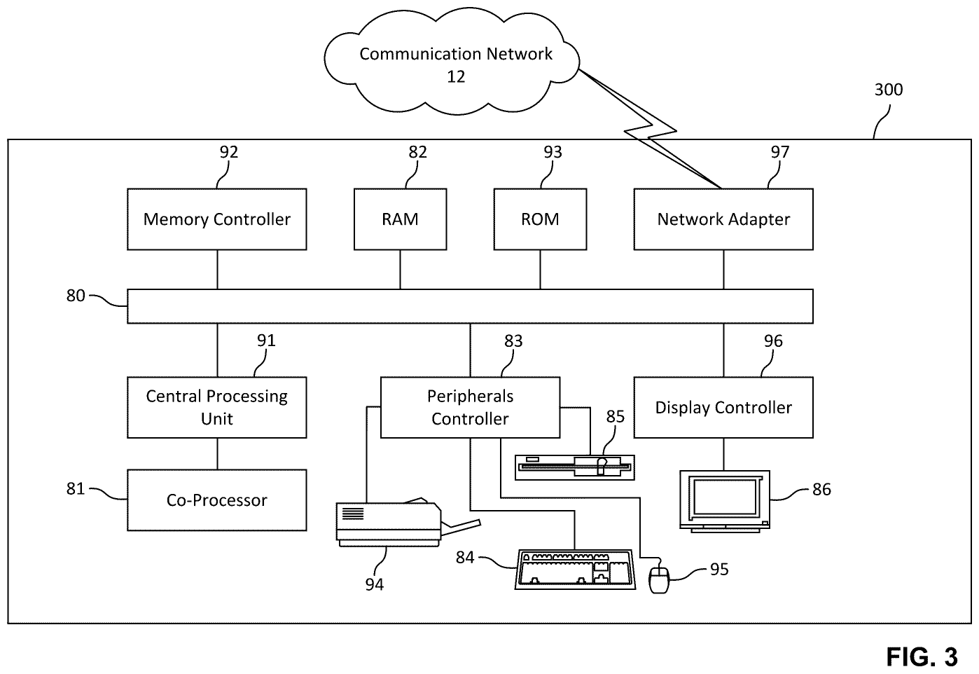

FIG. 3 is a block diagram of an exemplary computing system 300. In some exemplary embodiments, the network device 160 may be a computing system 300. The computing system 300 may comprise a computer or server and may be controlled primarily by computer-readable instructions, which may be in the form of software, wherever, or by whatever means such software is stored or accessed. Such computer-readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adapter 97, that may be used to connect computing system 300 to an external communications network, such as network 12 of FIG. 2, to enable the computing system 300 to communicate with other nodes (e.g., UE 30) of the network.

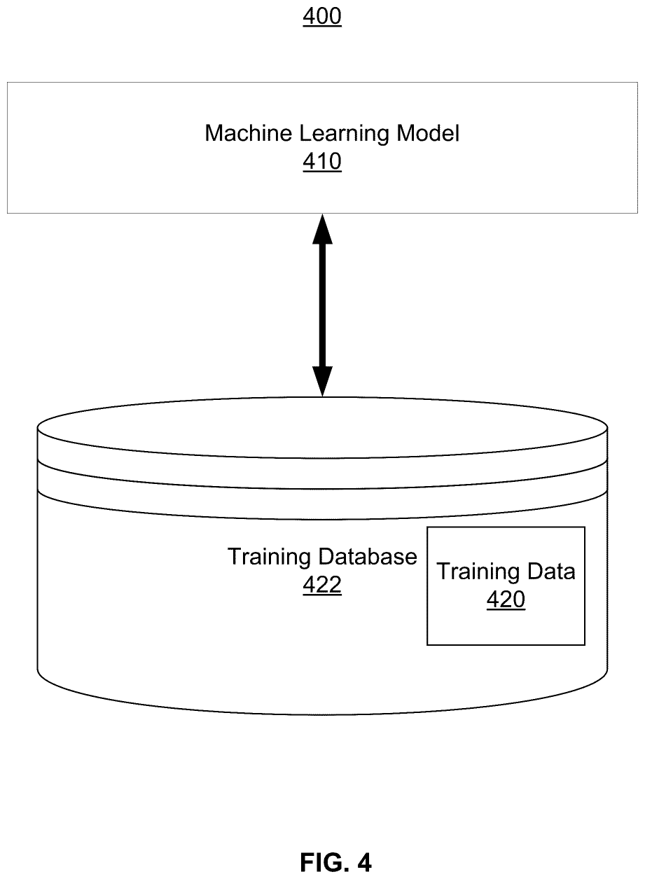

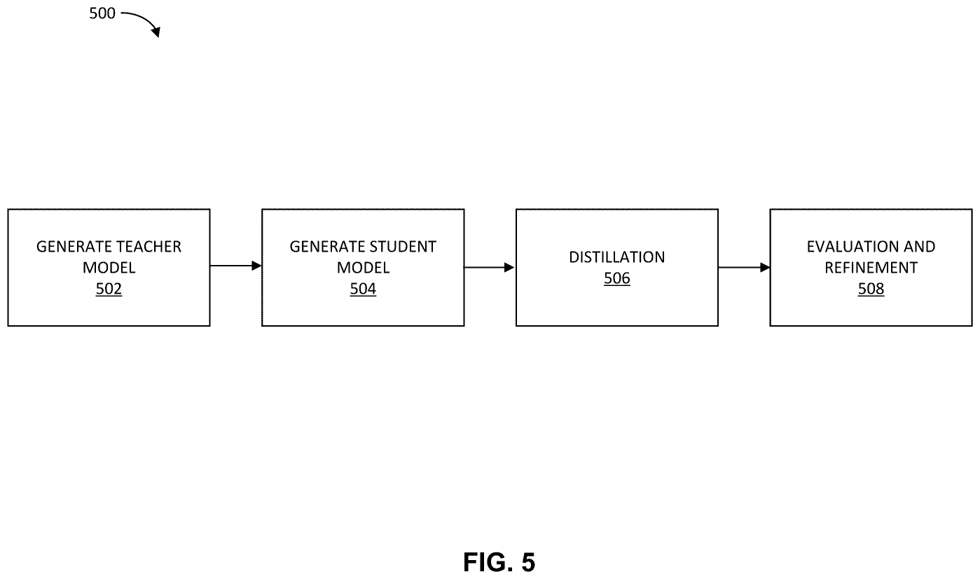

FIG. 4 illustrates a machine learning and training model, in accordance with an example of the present disclosure. The machine learning framework 400 associated with the machine learning model may be hosted remotely. Alternatively, the machine learning framework 400 may reside within a server 162 shown in FIG. 1, or be processed by an electronic device (e.g., head mounted displays, smartphones, tablets, smartwatches, or any electronic device, such as communication device 105). The machine learning model 410 may be communicatively coupled to the stored training data 420 in a memory or database (e.g., ROM, RAM) such as training database 422. In some examples, the machine learning model 410 may be associated with operations of FIGS. 5, 6, 7, 8A, 8B, 8C, 8D and 9. In some other examples, the machine learning model 410 may be associated with other operations. The machine learning model 410 may be implemented by one or more machine learning models(s) and/or another device (e.g., a server and/or a computing system). In some embodiments, the machine learning model 410 may be a student model trained by a teacher model, and the teacher model may be included in the training database 422.

### Exemplary System Operation

FIG. 5 illustrates an example process 500 for training a diffusion model, in accordance with one or more example aspects of the subject technology. A diffusion model (e.g., machine learning model 410) may be a type of generative AI model that progressively converts random noise into a structured output, such as an image or audio clip, through a series of learned steps.

The architecture of a diffusion model (also referred to herein as model) may be centered around a deep neural network, which may use convolutional layers when dealing with images, or recurrent layers for sequence data like audio or text. The operation of the diffusion model may include two primary phases: the forward diffusion process and the reverse generative process. In the forward diffusion, the diffusion model may gradually add noise (e.g., Gaussian noise) to the data over a series of timesteps, transforming the original data into pure noise. This is done in a way that each step of adding noise is statistically tractable, allowing the model to learn how the data is being corrupted at each timestep.

From a computation perspective, the forward diffusion process progressively generates corrupted data by interpolating between a sampled data point x₀ and Gaussian noise ϵ˜ [symbol] (0,1). That is,

$${x}_{t} = q ( {x}_{0} , ϵ ) = {α}_{t} {x}_{0} + {σ}_{t} ϵ , ∀ t ∈ [ 0 , T ] , \qquad ( 1 )$$

where αₜ represents the variance of the data distribution at step t of the diffusion process, and σₜ represents the standard deviation of the Gaussian noise added at each step in the reverse diffusion process. αₜ and σₜ may define the signal-to-noise ratio (SNR) of the stochastic interpolant xₜ. For example, a may adjust how much of the original data's variance is retained at each step, while σ may control the intensity of the noise being added. The coefficients (αₜ, σₜ) may give rise to a variance preserving process. When viewed in the continuous time limit, the forward diffusion process described by Eq. (1) may be expressed as a Stochastic Differential Equation (SDE):

$$dx = f ( x , t ) dt + g ( t ) {dw}_{t} ,$$

where f(x, t): [symbol] ^{d}→ [symbol] ^{d} is a vector-valued drift coefficient, g(t): [symbol] ^{D}→ [symbol] ^{D} is the diffusion coefficient, and wₜ denotes the Brownian motion at time t.

The reverse process (e.g., the actual generative phase) involves learning to denoise the data. Starting from the noise, the model may iteratively predict the noise that had been added at each previous step and remove it, thus gradually reconstructing the data from noise back to its original form. Each step of this reverse process may be modeled by a neural network, which may be trained to predict the noise or directly reconstruct the clean data (e.g., images) from the noisy input of the current step. This training uses the noise-added samples from the forward process as training data, optimizing a loss function that typically measures the difference between the actual noise used in the forward process and the noise predicted by the model during the reverse process.

From a computation perspective, the forward SDE introduced earlier may satisfy a reverse-time diffusion equation, which may be reformulated, to have a deterministic counterpart with the equivalent marginal probability densities, known as the probability, flow Ordinary Differential Equation (ODE):

$$dx = [ f ( x , t ) - \frac{1}{2} {g ( t )}^{2} {∇}_{x} log {p}_{t} ( x ) ] dt . \qquad ( 2 )$$

The marginal transport map of the probability flow ODE may be learned through maximum likelihood estimations of the perturbation kernel of diffused data samples ∇ₓ log pₜ(x|x₀) in a simulation-free manner. This gives an estimate \hat{ϵ}(xₜ, t)/σₜ≈∇ₓ log pₜ(x|x₀), usually parameterized by a time-conditioned neural network. Given these estimates, we may sample using an iterative numerical solver f:

$${\hat{x}}_{0} = f ∘ f ∘ … ∘ f ( {x}_{T} ) . \qquad ( 3 )$$

Without loss of generality, the discussion herein focuses on the update rule given by first-order solvers like Denoising Diffusion Implicit Models (DDIMs), e.g.:

$${x}_{t - 1} = f ( {x}_{t} ) = {α}_{t - 1} {\hat{x}}_{0} ( {x}_{t} , t ) + {σ}_{t - 1} \hat{ϵ} ( {x}_{t} , t ) , \qquad ( 4 )$$

where the sample data estimate \hat{x}₀ at timestep t is given by:

$${\hat{x}}_{0} ( {x}_{t} , \hat{ϵ} , t ) = \frac{{x}_{t} - {σ}_{t} \hat{ϵ} ( {x}_{t} , t )}{{α}_{t}} . \qquad ( 5 )$$

Diffusion models may be generated based on the concept of knowledge distillation, where the goal is to transfer knowledge from a complex model (teacher) to a simpler model (student). Training a student diffusion model through the process of distillation begins with the generation or accessing of a well-trained, high-performance teacher model (502). The teacher model may have already learned how to effectively perform the task at hand, such as image generation, through a series of forward (e.g., adding noise) and reverse (e.g., removing noise) diffusion steps, as described above. In some embodiments, the teacher model may be a pre-trained model.

Initially, the student model, which may be smaller and/or less complex, may be generated (504) with random and/or uninitialized parameters. The teacher model's capabilities in handling the forward and/or reverse diffusion may be distilled (506) into the student model. The distillation may be achieved by training the student model to reproduce the output distributions of the teacher model. As described above, this may involve the student learning to predict the noise that the teacher model may remove at each step of the reverse diffusion process, effectively learning to reverse the diffusion process like its teacher. For example, pairs of noisy and less noisy images generated by the teacher model may be used. For each training instance, the teacher model may receive a noisy input and produce outputs at one or more intermediate stages of the denoising process. The outputs may include both the predictions of the cleaner image at the next step and the estimated noise itself. The student model may then be trained to predict the same outputs given the same initial noisy inputs. To achieve this, a loss function may be designed to represent the difference between the student's predictions and the teacher's outputs. This loss function may include terms for accurately predicting the denoised image at each step and correctly estimating the noise that was removed by the teacher. Throughout the training, the student model's parameters may be adjusted based on the loss function (e.g., via gradient descent), optimizing them to reduce the discrepancy between its outputs and those of the teacher. This optimization may be facilitated by backpropagation, where the gradient of the loss function may be determined with respect to each parameter in the model. Over time, through repeated iterations over the training data, the student model learns to emulate the teacher model's behavior effectively, thereby gaining the ability to perform the denoising steps independently.

After training the student model on the training dataset by minimizing the discrepancy between its outputs and the output of the teacher model, the next step may involve evaluation and/or refinement of the student model (508). Evaluation may be performed by applying the student model to a separate validation dataset that was not used during training. The purpose of this evaluation may be to assess how well the student model generalizes to new, unseen data. During the evaluation phase, the performance of the student model may be measured using relevant metrics (e.g., Fréchet inception distance (FID), a multimodal model capable of associating images with associated text descriptions a benchmark model to determine compositional text-to-image synthesis (e.g., based on text-to-image generation)) that may include image fidelity, realism in generated images, and/or similarity to the outputs predicted by the teacher model, depending on the specific application of the model. If the student model's performance on the validation set is unsatisfactory, or if there are significant differences between its outputs and those of the teacher model, further refinement may be performed. Refinement may involve revisiting the model's architecture, adjusting the hyperparameters, extending the training period, and/or the like. Additional strategies may include enhancing the training dataset, employing regularization techniques to improve generalization, and/or tweaking the loss function to better capture other aspects of the output distribution. This iterative process of training, evaluating, and refining may continue until the student model achieves a desirable level of performance, ensuring both efficiency and effectiveness in its task.

Diffusion models, in contrast to other generative models such as GANs, approach density estimation and data sampling in an iterative way, by gradually reversing a noising process. This iterative nature translates to multiple queries of a neural network backbone, which may lead to high inference costs. Some challenges faced in reducing the inference costs may be the corresponding degradation of output image quality and/or text faithfulness. Some approaches to reducing inference costs include solvers and curvature rectification, which aim to linearize the inference path, allowing for larger step sizes, and therefore fewer steps at inference time. However, despite the substantial step reduction, there may be a limit on how large the inference step may be without compromise in image quality. Some approaches to reducing inference costs also include reducing the size of the student model. However, to truly scale inference for real-time applications, the number of steps performed may also be reduced. Some approaches to reducing inference costs further include sampling step reduction by distilling two or more steps into one. However, substantial quality degradation is evident when steps are distilled absent addition training enhancements during distillation.

Aspects of the subject technology provide a distillation framework in diffusion model training that is designed for a teacher model to improve a student model along the student model's diffusion paths. The distillation framework includes three components. First, a process called “backward distillation” calibrates the student model on its own upstream backward (e.g., denoising) trajectory, thereby reducing the gap between the training and inference distributions and reducing data leakage during training across time steps. Second, a process called “shifted reconstruction loss” dynamically adapts the knowledge transfer from the teacher model to the student model. Specifically, the loss may be designed to distill global, structural information from the teacher model at higher steps while focusing on rendering finer details and high-frequency components at lower time steps. This adaptive approach enables the student model to effectively emulate the teacher model's generation process at different stages of the diffusion trajectory. Lastly, a process called “noise correction” introduces an inference-time modification that may enhance sample quality by addressing singularities that may be present in noise prediction models during the initial sampling step. This training-free technique may mitigate degradation of contrast and color intensity that may arise when operating with an extremely low number of denoising steps. Applying this distillation framework to a baseline diffusion model allows for the generation of high-quality images in extremely low steps (e.g., 1-3 steps) and in near real-time without noticeable compromise of sample quality or conditioning fidelity.

In the following description, a pre-trained diffusion model (ϕ) is a teacher model that works in image and/or latent space and predicts score estimates (\hat{ϵ}_{ϕ}). If the teacher model uses classifier-free guidance (CFG), then this knowledge may also be distilled in the distillation framework and eliminate its need. The goal includes distilling the knowledge of the teacher model (ϕ) into a student model (θ), while reducing the overall number of sampling steps, and providing high-quality increases per extra step allowed in the student model.

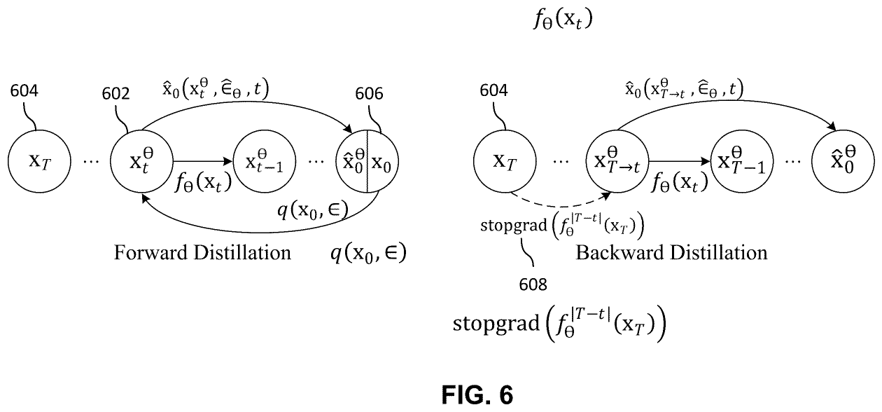

As shown in FIG. 6, forward distillation determines/computes gradients using the forward noise iterate xₜ (602) (the state of the data at some intermediate timestep t, during the reverse diffusion process, as generated by a parameterized model Θ). Backward distillation may reduce (e.g., eliminate) leakage for all steps t and prevents the student model from depending on ground truth (GT) signals.

It is recognized that some noise schedulers may often fail to achieve zero terminal SNR at t=T, thereby creating a discrepancy between training and inference. Specifically, the noise schedule (α_{T}, σ_{T}) in Eq. (1) is chosen such that x_{T} (604) is not pure noise during training, but rather contains low frequency information leaked from x₀ (the original data) (606). This discrepancy may lead to performance degradation during inference, especially when taking only a few steps. To overcome this issue, some approaches may rescale existing noise schedules under a variance preserving formulation to enforce zero terminal SNR.

Such approaches may not be sufficient, however, as information leakage may occur at all t via the forward diffusion Eq. (1). For example, the distillation loss gradient is determined/computed at every training step as follows:

$${∇}_{Θ} {‖ {\hat{x}}_{0} ( {x}_{t} , {\hat{ϵ}}_{Φ} , t ) - {\hat{x}}_{0} ( {x}_{t} , {\hat{ϵ}}_{Θ} , t ) ‖}^{2} , \qquad ( 6 )$$

where \hat{x}₀(⋅) is defined in Eq. (5). Now, since xₜ=αₜx₀+σₜx_{T} even when enforcing zero terminal SNR (x_{T}=ϵ), any stochastic interpolant xₜ, t<T (602) still contains information from the ground truth sample via the first summand αₜx₀. Consequently, the model learns to denoise given the information from the ground truth signal. The smaller the t, the stronger the presence of the signal, and thus the more it will learn to preserve it. Let

$${x}_{T \to t}^{Θ} = {f}_{Θ}^{\vert T - t \vert} ( {x}_{T} )$$

be the student model estimate at time t starting from pure noise at T in |T−t| steps (see Eq. (4)). During inference, the signal contained in

$${x}_{T \to t}^{Θ}$$

is no longer ground truth signal x₀ (606), but rather the model's own best guess of

$${x}_{0}^{Θ} := {\hat{x}}_{0} ( {x}_{t - 1} , {\hat{ϵ}}_{Θ} , t + 1 )$$

from the previous step (see Eq. (3)). As a result, models that have been trained to preserve given signal will continue to propagate errors from previous steps instead of correcting them.

Aspects of the subject technology may introduce a solution to provide signal consistency between training and inference at all times t. This may be achieved by simulating the inference process during training, which is referred to herein as “backward distillation.” Compared to standard forward distillation, the gradients may not be determined/computed from the forward noised iterate xₜ (602), but instead starts from the student model's backward iterate

$${x}_{T \to t}^{Θ} = stop grad ( {f}_{Θ}^{\vert T - t \vert} ( {x}_{T} ) ) ,$$

as shown as 608 in FIG. 6. That is,

$${∇}_{Θ} {‖ {\hat{x}}_{0} ( {f}_{Φ}^{k} ( {x}_{T \to t}^{Θ} , ) , {\hat{ϵ}}_{Φ} , 0 ) - {\hat{x}}_{0} ( {x}_{T \to t}^{Θ} , {\hat{ϵ}}_{Θ} , t ) ‖}^{2} , \qquad ( 7 )$$

$$where$$

$${x}_{0}^{Φ} := {\hat{x}}_{0} ( {f}_{Φ}^{k} ( {x}_{T - t}^{Θ} ) , {\hat{ϵ}}_{Φ} , 0 )$$

constitutes the teacher target after k time uniform denoising steps with CFG starting from the current iterate.

To summarize, backward distillation reduces (e.g., eliminates) information leakage at every t, thereby preventing the student model from depending on a ground truth signal. Since this is achieved by simulating the inference process during training, it may also be interpreted as calibrating the student model on its own upstream backward diffusion path.

FIG. 7 depicts a second component of the distillation framework, shifted reconstruction loss (SRL), which may be performed in addition to or instead of the first component, backward distillation. A new distillation loss shown in FIG. 7 may improve the structure and adherence to detail of the student model's output. Item 702 may be the current iterate at timestep t in the context of backward distillation. Item 704 may be the image predicted (also referred to herein as generated or inferred) by the student model in one step from item 702. SRL then entails noising item 702 again to item 706 specified by the shifting function 708, followed by k uniformly sampled denoising steps from the teacher model. The shifts may be designed to adapt the type of knowledge distilled from the teacher mode for different ts in order to maximize efficacy.

In the process of image generation through backward diffusion, the initial stages (e.g., where t is close to T) may be useful in formulating the image's structure and composition. Conversely, the final stages (e.g., where t is near 0) may be useful for the creation of high-level details. Drawing from this observation, aspects of the subject technology provide enhancements to the default knowledge distillation loss, which incentivizes distilling both the structural composition and detail-rendering ability of the teacher model. Since this may involve shifting starting points for the teacher denoising away from the student t, we refer to this method as SRL. FIG. 7 shows an overview of a new distillation loss to improve the structure and adherence to detail of the student's predictions.

With SRL, instead of running the teacher model from the current iterate as in Eq. (7), the target is generated from the student model's prediction

$${x}_{0}^{Θ} = {\hat{x}}_{0} ( {x}_{T \to t}^{Θ} , {\hat{ϵ}}_{Θ} , t )$$

noised to

$${t}_{Φ} = γ ( t ) ,$$

which is also referred to herein as
Xₜ_{_{Φ}}.

As a result, the gradient updates may be determined/computed as

$${∇}_{Θ} {‖ {\hat{x}}_{0} ( {f}_{Φ}^{k} ( {χ}_{t , Φ} , ) , {\hat{ϵ}}_{Φ} , 0 ) - {\hat{x}}_{0} ( {x}_{T \to t}^{Θ} , {\hat{ϵ}}_{Θ} , t ) ‖}^{2} . \qquad ( 8 )$$

Contrary to other approaches to step distillation,

$$γ : [ o , T ] \to [ 0 , T ]$$

is not defined as the identity function γ(t):=t, but it is rather designed so that for large values of t, the teacher target exhibits global content similarity with the student output but with superior semantic text-alignment. Conversely, for smaller values of t, the teacher image enhances high-quality details, while preserving the identical structure as the student. This approach directs the student to concentrate on distilling the structural knowledge during the initial backward steps, and to focus on generating high-level details generation toward the final backward steps.

The third component to the distillation framework includes noise correction, a training-free inference modification that increases sample quality of few step approaches that were trained in noise prediction mode.

Diffusion models may be trained in noise prediction mode, which tasks the model with separating noise (e.g., Gaussian noise pixels) from signal (e.g., image pixels) given a randomly corrupted image (e.g., image pixels combined with Gaussian noise pixels). The process of sampling from diffusion models, however, may start from a point of pure noise, such as x_{T}=ϵ with ϵ˜ [symbol] (0, I). As a result, there may be no signal to be found/determined in x_{T} and hence noise prediction at T may become trivial but may be completely uninformative for the image generation process. To circumvent this singularity, some approaches modify the noise schedule in Eq. (1) such that α_{T}=0 and σₜ=T and switch to velocity prediction. Together, these changes may help the first update step at T be informative and unbiased.

However, converting a model to velocity prediction may involve extra training efforts. Alternatively, other approaches (e.g., few step approaches) may instead decide to remain in noise prediction mode, but may determine/compute loss on \hat{x}₀. While this may circumvent the triviality problem of noise prediction at T, it may also introduce a bias in the first update step. To see this, consider the first-order update in Eq. (3). The update step f(xₜ) constitutes as a weighted sum of the current estimated signal \hat{x}₀, and the model output ϵ_{θ}. For noise prediction models, the estimated signal is a function of ϵ_{θ} itself (Eq. (5)). Now, since only the former (\hat{x}₀) goes into the loss (see Eq. (6)) and since there is no signal whatsoever in x_{T}, the model is explicitly tasked not to predict ϵ_{θ}=ϵ (which may give an all black image and hence high loss). As a result, using ϵ_{θ} for the second part the update step in Eq. (3) biases the denoising process leading to error accumulations.

To resolve this issue, aspects of the subject technology provide a simple, training-free alternative to switching to zero-SNR velocity prediction that allows the usage of noise prediction models without the aforementioned bias. Namely, treating t=T as a unique case and replacing ϵ_{θ} with the true noise x₇, the update f is corrected:

$${f}_{Θ} ( {x}_{t} ) = \{ \begin{matrix}{α}_{t - 1} {\hat{x}}_{0} ( {x}_{T} , {\hat{ϵ}}_{Θ} , T ) + {σ}_{T - 1} ϵ & if t = T . \\ {α}_{t - 1} {\hat{x}}_{0} ( {x}_{t} , {\hat{ϵ}}_{Θ} , t ) + {σ}_{t - 1} {\hat{ϵ}}_{Θ} ( {x}_{t} , t ) & if t < T .\end{matrix} \qquad ( 9 )$$

This approach may significantly improve the estimated colors, resulting in more vibrant and more saturated hues. This effect is particularly pronounced when the number of inference steps is low.

In some embodiments, the student model may be trained with an additional adversarial loss for improved image quality. In some embodiments, a GAN discriminator may be used. For single step models, better image quality may be available with a discriminator (e.g., a U-Net-based discriminator) crafted from the teacher (e.g., a U-Net teacher). In some embodiments, timesteps t∈{999, 750, 500} and t∈{999, 666} may be used for a 3-step and 2-step model, respectively. For shifted reconstruction loss, in some embodiments, may be γ(t>900):=990; γ(900≥t>500):=950; and γ(t≤500):=200. From there, the teacher model may take k=8 time uniform steps. Training may be conducted for 15k steps, using an optimizer (e.g., an adaptive learning rate optimizer capable of improving training speeds in deep neural networks) with a learning rate of 5e-6 for a U-Net and 1e-4 for the discriminator. The resulting student model may achieve results matching the pre-trained teacher model's performance using only three denoising steps while consistently outperforming other similar approaches. The student model's efficiency combined with its high output quality and diversity may make it well-suited for near real-time or on-the-fly, high-fidelity generative applications.

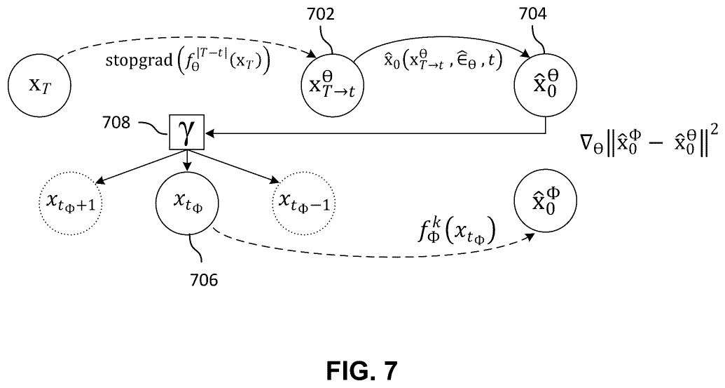

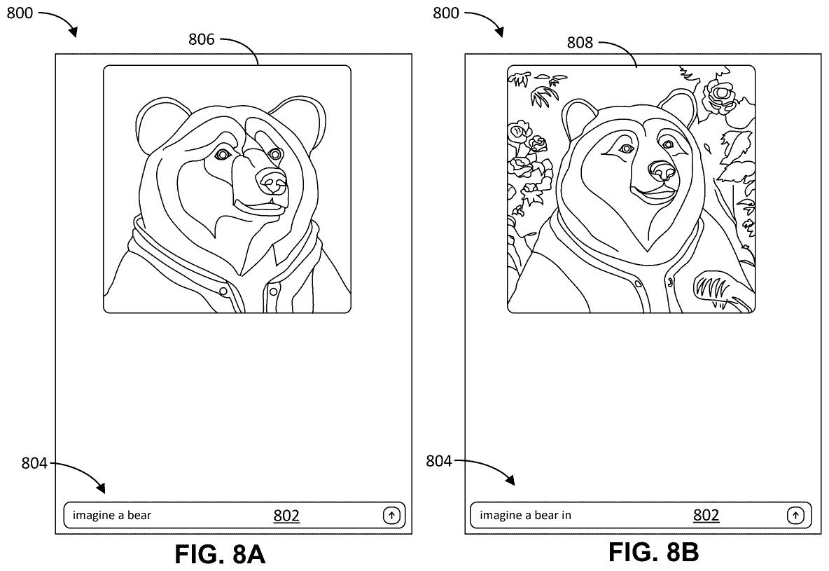

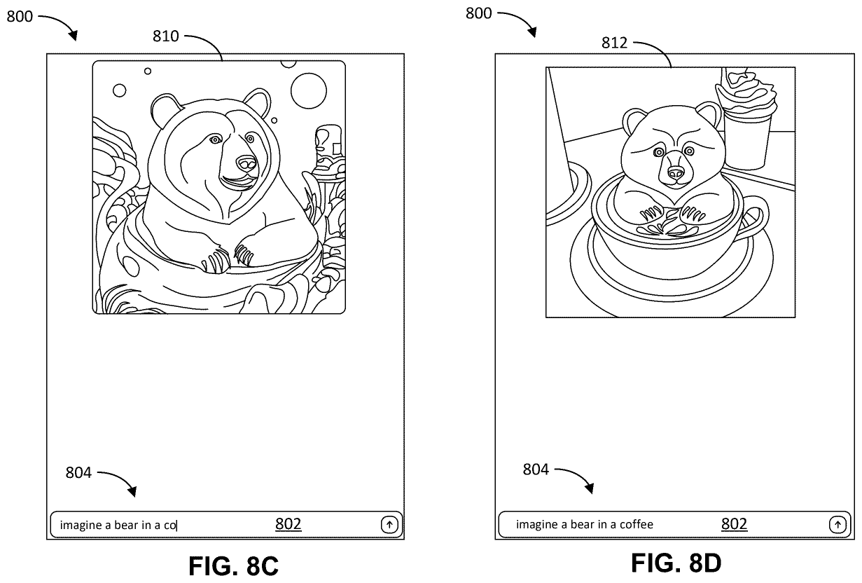

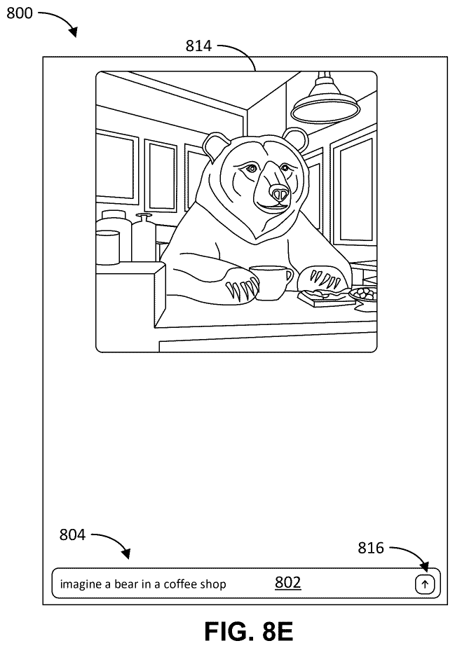

Referring now to FIGS. 8A, 8B, 8C, 8D and 8E, a typeahead user interface 800 for utilizing a trained diffusion model is shown. The diffusion model may be trained according to one or more of the processes described above, for example, with respect to FIGS. 5, 6 and 7.

The diffusion model may be hosted on a cloud server (e.g., server 162). The cloud server may include specialized hardware for machine learning tasks, such as GPUs or TPUs. The cloud server may be designed to scale efficiently under varying loads, employing auto-scaling and load balancing techniques. For example, a platform that automates scaling, deployment and management of applications (e.g., containerized applications) may be utilized to orchestrate containers that encapsulate the model so that resources may be efficiently managed and may dynamically scale. Each container may run instances of the model, and the load balancer may distribute incoming requests among these instances to optimize resource utilization and response time. Caching strategies may also be utilized at the cloud server, particularly for frequently requested prompts or similar queries. Implementing an in-memory data store (e.g., a high speed in-memory data store utilized as a cache, message broker, database, and/or the like having speed and/or versatility in managing data types), may help in storing pre-determined/pre-computed results for popular or repeated prompts, thereby reducing the need to reprocess identical requests and speeding up response times. Moreover, the cloud service may also implement a microservices architecture to enhance modularity and maintainability. For instance, separating the text processing, image generation, and user management into different services may allow for more manageable updates and scalability. Each service may communicate via pre-defined APIs, possibly using a message broker (e.g., a platform(s) capable of streaming, processing and storing data in real-time that may be utilized to generate applications adaptable to data streams) for handling asynchronous communication, ensuring robustness and scalability.

To interact with the diffusion model, the user interface 800 may be presented on an application (e.g., a web application and/or a dedicated application) running on a mobile device (e.g., communication device 110) of a user. The user interface 800 may be designed to be responsible for collecting user inputs and displaying the generated images. When a user inputs a text description (e.g., a prompt 804) in an input field 802 of the user interface 800 to initiate image generation, the application may package the text into a structured data format, such as JSON, for the application to send the text over the Internet (e.g., via network 140) to the server, for example, through a secure application programming interface (API). The server may host the diffusion model, which possesses the computational resources necessary to process the input text and perform the complex operations of the diffusion process.

The server may receive the input and process it, for instance, by tokenizing the text, embedding the text for semantic analysis, and/or running the reverse diffusion process with the diffusion model to generate an image from noise. This approach may allow computationally intensive tasks (e.g., inference) to be offloaded from the mobile device, thereby preserving battery life and helping the app remain responsive. Once the image is generated, the image may be sent back to the mobile device, for example, through the same API. The application on the mobile device may then receive the image data, for example, in a compressed image format suitable for mobile viewing, and displays it to the user. In some embodiments, this process may also involve error handling mechanisms, such as timeouts or retries, to manage potential issues with network connectivity or server responsiveness.

To demonstrate, as shown in FIG. 8A, the user may begin to input a prompt 804 for the diffusion model. The prompt 804 as shown reads “imagine a bear.” Due to the significantly improved performance of the diffusion model described above, the image 806 may be generated and received within one second (e.g., p95 is 750 ms) in ordinary situations. The improved performance of the diffusion model allows for the application on the mobile device to have a typeahead functionality for image generation where images may be dynamically generated as the user types the prompt. The typeahead functionality enhances user engagement and allows for immediate visual feedback and iterative refinement of prompts.

As the user begins to input characters of the prompt 804 into the input field 802, each incremental addition may trigger a query to the server, which in turn prompts the diffusion model to generate an image 806 based on the incomplete text input. This process utilizes the ultra-low latency and high throughput of the model, allowing for near-instantaneous generation of visuals while typing and without pressing the submit button. For example, as shown in FIG. 8B, the user has added “in” to the prompt 804. Although “in” does not convey additional, meaningful context to the prompt, the prompt 804 is still sent to the server as each character is entered and image generation is performed as each character is input. As a result, the diffusion model may generate a new image 808 of the bear in a bed of flowers.

If the user is satisfied with the image, the user may stop adding input and save the image. Otherwise, the user may continue adding input. For example, the user may continue typing “imagine a bear in a co,” as shown as prompt 804 in FIG. 8C. The new image 810 may be a vague interpretation of a bear in some object, as “coffee” is being typed. Each new image may become progressively more like a bear in a coffee (e.g., image 812) as more of the prompt is entered until the entire prompt 804 “imagine a bear in a coffee” is complete, as shown in FIG. 8D.

This immediate feedback loop may help users refine their prompts on-the-fly, adjusting their input based on the visual output observed. For example, if the user does not want to visualize a bear in a coffee, as in image 812, the user may add other words to generate new images. The user may add the word “shop” to the prompt to generate an image of a bear in a coffee shop, as shown in FIG. 8E as image 814. As each letter in the word “shop” is added to the prompt, a new image may be generated, each image becoming progressively more like a bear in a coffee shop as more of the prompt is entered until the entire phrase “image a bear in a coffee shop” is complete, as shown in FIG. 8E as image 814.

In some embodiments, the prompt 804 input to the diffusion model at the server may be supplemented with additional information, which may be provided by the application and/or by the server for a particular prompting session. For example, the input may also include a seed, which may refer to a starting point for random number generation used during the sampling process of the diffusion model. The seed may allow for the reproducibility of results. By initializing the random number generator with the same seed, the diffusion model may generate the similar output each time given the same initial conditions and prompt. For example, as the images progress from FIGS. 8A, 8B, 8C, 8D to FIG. 8E, the bear appears generally the same throughout. That is, the bears are generally the same color, facing generally the same direction, and generally are in the same pose. This may be due to keeping the seed constant throughout a prompting session. The seed may be changed by starting a new prompting session, for example, by clearing the prompt or pressing the submit button 816.

Maintaining the same seed in a prompting session may be valuable for users who may want to recreate a specific image without variations. For example, if the user prompted “imagine a bear in a coffee shop,” as shown in FIG. 8E, but wanted to return to the original image 806 of the bear, as shown in FIG. 8A, the user may simply remove the characters “in a coffee shop” and the image 806 from FIG. 8A may be regenerated because the seed has stayed the same. However, if the user clears the prompt 804 and enters a new prompting session, a new seed may be generated. Consequently, if the user then inputs “imagine a bear,” the image may not depict a brown bear, for example, but may instead depict a polar bear or a brown bear but in a different pose.

In some example aspects, the application on which the user interface 800 is displayed may include a caching mechanism that caches the generated images in a prompting session. When the user modifies a prompt, for example, to remove “in a coffee shop,” the application may retrieve the image that was associated with the prompt “imagine a bear” from the same prompting session and display the image 806 of FIG. 8A. This may reduce the amount of network traffic between the mobile device and the server and may improve the responsiveness of the application.

In some example aspects, the application may record the changes in the prompt 804 along with the image generated in association with each change in the prompt 804. The images 806, 808, 810, 812, 814 may be compiled together to form a video, slideshow, or other multimedia representation resembling a sort of timelapse that captures the evolution of the image as the prompt 804 is changed within a prompting session. The prompt 804 may be overlaid upon or placed alongside the video to show what changes in the prompt correspond to the generated image. The video may be generated by the application on the mobile device and/or by the server.

In some example aspects, to reduce the amount of network traffic between the mobile device and the server, the application may dynamically decide whether to block the transmission of the prompt to the server. In one approach, the application may set a threshold number of characters before which the prompts may be blocked from transmission. For example, the application may block prompts until they have at least seven characters, because prompts having fewer than seven characters may not have any significant meaning and thus may generate nonsensical images, wasting computation resources utilizing the diffusion model. Additionally or alternatively, in another approach, the application may include a list of words that when appended to the prompt 804 may cause the prompt 804 to be blocked from transmission. For example, although a prompt 804 is sent to the server for each character as the user is typing, if the application detects that the added characters represent words such as “the,” “a,” and/or any other stop words or phrases, the application may block the prompt 804 from being transmitted to the server, since stop words may not cause the generation of a materially different image. Additionally or alternatively, in yet another approach, a delay timer may be added before the prompt 804 is transmitted to the server. For example, in the scenario in which the user types quickly, the application may have a delay of 500 milliseconds (ms) before transmitting the prompt to the server. The delay may be reset as a new character is input. This may allow the user to type complete words or phrases, thereby allowing more semantically meaningful prompts to be sent to the server.

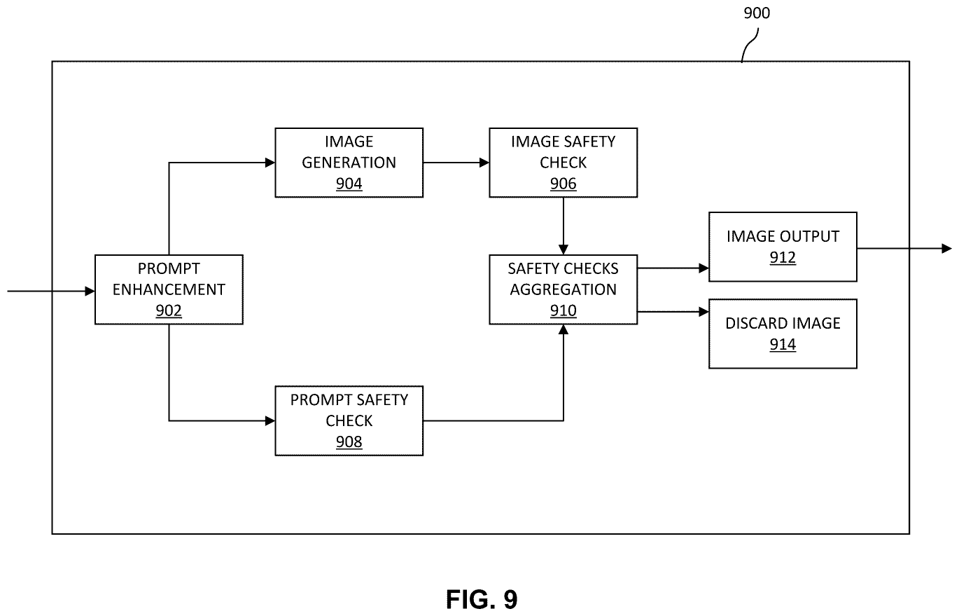

FIG. 9 depicts a block diagram of a prompt processing pipeline 900, in accordance with one or more example aspects of the subject technology. As discussed above, the diffusion model may reside on the server to handle one or more clients, including the mobile device of the user. Safety and integrity checks in image generation models may be provided to confirm that the generated content adheres to certain guidelines and, for example, does not produce harmful or inappropriate images. These checks may be integrated into the prompt processing pipeline to filter and regulate the output based on pre-defined safety protocols and content policies. From a performance perspective, safety and integrity checks may have a significant impact on the overall latency and throughput of the image generation process. Each layer of filtering and review may consume computational resources and time. Automated checks, while faster than manual reviews, may still require processing power and may slow down the response time that users experience. For instance, deploying complex classifiers to inspect images may add a non-trivial amount of time to the generation process, depending on the efficiency of the algorithms, and/or applications and the available computing power.

In some approaches to safety and integrity checks, safety and integrity checks may involve multiple layers of moderation and filtering both before and after the image generation process. Additionally, once an image is generated, post-processing checks may be applied.

Aspects of the subject technology reduce the amount of time taken for safety and integrity checks by parallelizing one or more of the safety and integrity checks, as described below.

The prompt processing pipeline 900 may be run on a server (e.g., server 162). When the server receives an input prompt (e.g., “imagine a bear”), the prompt (e.g., prompt 804) may be run through one or more blocks, where each block represents one or more software applications, AI models, heuristics, algorithms, and/or the like. At 902, the prompt may be enhanced. Prompt enhancers may utilize a combination of natural language processing techniques to understand and/or manipulate the text of the prompt, and machine learning models that may be trained on a diverse dataset to recognize and/or suggest enhancements that are creative and/or contextually appropriate. Prompt enhancement may include a prompt diversity handler, which may analyze the prompt and suggest variations and/or expansions that may increase the diversity of the generated output. This may involve recommending synonyms, incorporating additional descriptive elements, and/or suggesting entirely new themes related to the original prompt. For example, if a user inputs “a sunny day in a park,” the diversity enhancer may suggest variations like “a bright day in a park” or “a sunny day by a riverside,” thereby broadening the scope and variety of imagery that the model may generate by encouraging more varied inputs. Prompt enhancement may also include a prompt background enhancer, which may add depth and context to the prompt with background details that may not be explicitly mentioned but may enhance the quality and specificity of the generated images. For purposes of illustration and not of limitation, for example with a prompt like “medieval battle scene,” the background enhancer may add specifics such as “during the early Renaissance, with foggy weather and knights wearing historically accurate armor from the 14th century.” By providing richer context, the diffusion model may generate images that may not only be visually appealing but also may be contextually accurate and rich in detail.

After prompt enhancement 902, the prompt may be checked for safety 908 while also being provided to the diffusion model for image generation 904. Rather than checking the prompt before image generation 904, the prompt processing pipeline 900 may be streamlined by performing prompt safety checks while simultaneously performing image generation.

Image generation 904 may be performed with the enhanced prompt. The prompt may be processed by a text encoder that converts the natural language input into a high-dimensional embedding vector, which encapsulates the semantic content of the text in a form that is amenable to numerical processing. The embedding may then be used as the initial condition or input to the distilled diffusion model. As described above, the diffusion model may operate by gradually refining an initial random noise pattern into a coherent image. This is achieved through a series of iterative steps, where the diffusion model predicts and subtracts a portion of the noise at each step, progressively denoising the image. Each denoising step involves conditioning on the text embedding, so that the emerging image aligns with the semantic cues provided by the prompt. The diffusion model described above may generate the image on the order of a couple steps (e.g., 1-5 steps). The output of the diffusion model may be a clear, detailed image that corresponds to the textual description provided in the prompt.

As the image generation 904 is performed, the prompt safety checks 908 may also be performed. Because the prompt safety checks 908 occur in parallel with image generation 904, there may be no preemptive blocking of image generation 904 based on any issues identified in the prompt. Such safety checks may include content filtering that analyzes the prompt for any explicit, sensitive, or otherwise inappropriate language. Content filtering may involve both keyword-based checks and/or natural language processing systems that may infer the intent and context of the prompt. Content filtering may also involve utilizing machine learning classifiers that attempt to quantitatively assess the likelihood of a prompt resulting in the generation of unacceptable content. Based on a range of factors-such as the words used, their combinations, and the model's historical data on similar prompts-a risk score may be determined/computed for the prompt. If the prompt exceeds a certain threshold, it may be classified as unsafe. The safety checks may also include a pre-defined list of prohibited terms or concepts, and any prompt containing these may be automatically rejected and/or flagged for manual review. Safety checks may also include private name removal for privacy and compliance with data protection regulations. Private name removal may include scrubbing names that are not publicly recognizable or associated with public figures. Safety checks may also include risk throttling where the certain functionality may become limited as risk increases, such as reducing the frequency at which the user may request image generations if their previous prompts have repeatedly triggered content warnings. Throughout any of the prompt safety checks 908, if an issue arises with the prompt (e.g., the prompt includes lewd or illicit content), the prompt may be flagged and/or scored based on the amount or severity of the issue. In some embodiments, a flag may be a binary score.

Image safety checks 906 may similarly be performed after the image is generated. Image safety checks 906 may include automated visual recognition systems trained to identify and flag content that violates specific guidelines, such as depictions of violence and inappropriate or sensitive content. The visual recognition systems may employ machine learning classifiers that have been trained on labeled datasets of unsuitable content to recognize a wide array of unsuitable content. Additionally, to prevent the regeneration of previously identified inappropriate content, images may be hashed and compared against a database of hashes of known inappropriate images. If a match is found, the image may be automatically flagged (e.g., to be discarded). Safety checks may also include risk throttling where certain functionality may become limited as risk increases, such as restricting the detail or realism of the generated images if previous prompts have repeatedly triggered content warnings. Throughout any of the image safety checks 906, if an issue arises with the image (e.g., the image includes lewd or illicit content), the image may be flagged and/or scored based on the amount or severity of the issue.

At safety checks aggregation 910, the outcomes of the prompt safety checks and/or the image safety checks (e.g., risk scores) may be reconciled, compared, or otherwise utilized independently and/or together to determine whether the generated image should/may be output or discarded. Reconciling the outcomes of prompt safety checks with those of image safety checks may help further maintain the overall integrity and safety of the processing pipeline. The processes of the aggregation 910 may involve one or more approaches where the results of one set of checks may influence, or even override, the results of the other. Generally, if a prompt passes initial safety checks, but the resulting image is flagged as inappropriate, the image check may serve as a fail-safe that may override the initial clearance of the prompt, as sometimes the semantic interpretation by the model may generate unexpected or inappropriate visual content that may not be explicitly detailed in the prompt.

Conversely, if a prompt is flagged as potentially risky, but the generated image is deemed safe and appropriate, the system may still deny (e.g., hold or reject) the image based on the risk associated with the prompt. This precautionary approach may be used so that the system may not inadvertently generate and approve images that may be seen as safe in isolation, but problematic in context. Like the prompt safety checks 908 and/or the image safety checks 906, the safety checks aggregations 910 may be automated with thresholds and/or rules defined based on the risk tolerance of the deployment environment. High-risk environments, such as those accessible by minors or used in educational settings, may favor stricter overrides where any risk flag leads to rejection. More permissive environments may allow for more nuanced decision-making, possibly incorporating additional human review. This flexible, context-sensitive approach helps the processing pipeline 900 adhere to pre-determined safety standards while adapting to specific user needs and environments.

The outcome of the safety checks aggregation 910 may be a decision to output the image (912) if the image is approved for release or to discard the image (914) if it is determined that the image is not approved for release. For example, a reconciled risk score may be generated by reconciling the risk score from the prompt safety checks 908 with the risk score from the image safety checks 906. The reconciled risk score may be compared to a pre-determined threshold risk score. If the reconciled risk score is lower than the threshold risk score, indicating a lower level of risk, the image may be approved, and vice versa.

If the image is approved, it may be provided to the user device. If the image is not approved, it may be discarded. In some embodiments, if the image is not approved, one or more penalties may be imposed. Penalties may include strikes, throttling, debouncing, deprioritizing, and/or the like. Strikes may include the server registering a strike against the user such that if the user reaches a particular number of strikes, for example, the user may be blocked from generating new images. Throttling may include reducing the number of images the user may generate per time period for a particular amount of time. Debouncing may include delaying the processing of the input until a certain amount of time has passed without any further input. Deprioritizing may include placing the user's request at the end of a queue or directing the user's request to a busier system so that the images are not generated as quickly for the user.

In some embodiments, as the images are output, the images may also be cached. Caching the images may improve efficiency in the event that the system receives the same set of inputs (e.g., prompt and seed) for the model so that the model does not have to regenerate the image. Caching the images may also improve the user experience as the user may expect the same set of inputs to the model to result in the same image.

In some embodiments, the server may record the changes in the prompt along with the image generated in association with each change in the prompt. The images may be compiled together to form a video resembling a sort of timelapse that captures the evolution of the image as the prompt is changed within a prompting session. The prompt may be overlaid upon or placed alongside the video to show what changes in the prompt correspond to the generated image. The video may be transmitted to the user, for example, after a prompting session is completed.

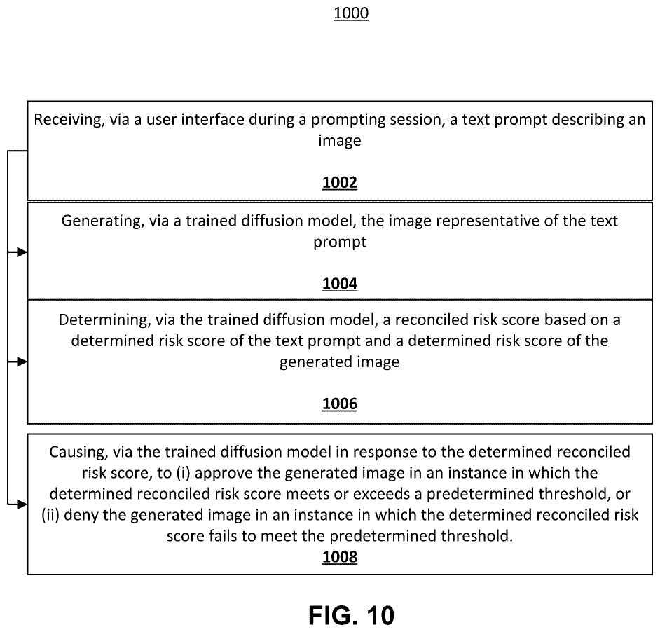

According to another embodiment as depicted in FIG. 10, a flowchart 1000 of an example technique to process text prompts is provided. Step 1002 of the method may include receiving, via a user interface during a prompting session, a text prompt describing an image. Step 1004 of the method may also include generating, via a trained diffusion model, the image representative of the text prompt. Step 1006 of the method further may include determining, via the trained diffusion model, a reconciled risk score based on a determined risk score of the text prompt and a determined risk score of the generated image. Step 1008 of the method even further may include causing, via the trained diffusion model in response to the determined reconciled risk score, to (i) approve the generated image in an instance in which the determined reconciled risk score meets or exceeds a predetermined threshold, or (ii) deny the generated image in an instance in which the determined reconciled risk score fails to meet the predetermined threshold.

### Alternative Embodiments

The foregoing description of the embodiments has been presented for the purpose of illustration; it is not intended to be exhaustive or to limit the patent rights to the precise forms disclosed. Persons skilled in the relevant art may appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which may be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, via a user interface during a prompting session, a text prompt describing an image;
generating, via a trained diffusion model, the image representative of the text prompt;
determining, via the trained diffusion model, a reconciled risk score based on a determined risk score of the text prompt and a determined risk score of the generated image; and
causing, via the trained diffusion model in response to the determined reconciled risk score, to (i) approve the generated image in an instance in which the determined reconciled risk score meets or exceeds a predetermined threshold, or (ii) deny the generated image in an instance in which the determined reconciled risk score fails to meet the predetermined threshold.

2. The method of claim 1, wherein the text prompt comprises a seed indicating a constant attribute associated with the image for a duration of the prompting session.

3. The method of claim 1, further comprising:
transmitting, via the user interface, an indication to enhance the received text prompt describing the image.

4. The method of claim 1, wherein:
the text prompt comprises a first text prompt and a second text prompt; and
the generated image of the second text prompt is different from the generated image of the first text prompt.

5. The method of claim 1, further comprising:
prior to transmitting the text prompt to the trained diffusion model, determining the text prompt comprises a threshold number of characters.

6. The method of claim 5, wherein the determining the text prompt comprises evaluating the text prompt for one or more characters indicating insufficient data to generate the image.

7. The method of claim 5, wherein the determining the text prompt comprises monitoring a predetermined amount of time elapsed after receiving the text prompt.

8. The method of claim 1, further comprising:
causing the approved generated image to be displayed on the user interface.

9. The method of claim 1, wherein the denial is a discard or a hold of the generated image.

10. The method of claim 1, wherein the trained diffusion model is located on a server operably coupled to the user interface.

11. The method of claim 8, wherein the trained diffusion model comprises a trained student diffusion model distilled with any one or more of backward distillation, shifted reconstruction loss, or noise correction.

12. A system comprising:
a non-transitory memory comprising instructions stored thereon; and
at least one processor, operably coupled to the non-transitory memory, configured to execute the instructions comprising:
receiving, via a user interface during a prompting session, a text prompt describing an image;
generating, via a trained diffusion model, the image representative of the text prompt;
determining, via the trained diffusion model, a reconciled risk score based on a determined risk score of the text prompt and a determined risk score of the generated image; and
causing, via the trained diffusion model in response to the determined reconciled risk score, to (i) approve the generated image in an instance in which the determined reconciled risk score meets or exceeds a predetermined threshold, or (ii) deny the generated image in an instance in which the determined reconciled risk score fails to meet the predetermined threshold.

13. The system of claim 12, wherein the text prompt comprises a seed indicating a constant attribute associated with the image for a duration of the prompting session.

14. The system of claim 12, wherein the at least one processor is further configured to execute the instructions of:
transmitting, via the user interface, an indication to enhance the received text prompt describing the image.

15. The system of claim 12, wherein:
the text prompt comprises a first text prompt and a second text prompt; and
the generated image of the second text prompt is different from the generated image of the first text prompt.

16. The system of claim 12, wherein the at least one processor is further configured to execute the instructions of:
prior to transmitting the text prompt to the trained diffusion model, determining the text prompt comprises a threshold number of characters.

17. The system of claim 16, wherein the determining the text prompt comprises evaluating the text prompt for one or more characters indicating insufficient data to generate the image.

18. The system of claim 16, wherein the determining the text prompt comprises monitoring a predetermined amount of time elapsed after receiving the text prompt.

19. A non-transitory computer readable medium comprising stored instructions that when executed effectuates:
receiving, via a user interface during a prompting session, a text prompt describing an image;
generating, via a trained diffusion model, the image representative of the text prompt;
determining, via the trained diffusion model, a reconciled risk score based on a determined risk score of the text prompt and a determined risk score of the generated image; and
causing, via the trained diffusion model in response to the determined reconciled risk score, to (i) approve the generated image in an instance in which the determined reconciled risk score meets or exceeds a predetermined threshold, or (ii) deny the generated image in an instance in which the determined reconciled risk score fails to meet the predetermined threshold.

20. The non-transitory computer readable medium of claim 19, wherein the stored instructions when executed further effectuates:
causing the approved generated image to be displayed on the user interface.
